(19) United States
(12) Patent Application Publication
(10) Pub. No.: US 2021/0207756 A1
(43) Pub. Date: Jul. 8, 2021

(54) Method of Reinforcing Pipe and Reinforced Pipe

(71) Applicant: INA ACQUISITION CORP., Wilmington, DE (US)

(72) Inventors: Ian Lancaster, San Diego, CA (US); Amber Wagner, San Diego, CA (US); Victor Reyes, San Diego, CA (US); Reymundo Ortiz, San Diego, CA (US)

(21) Appl. No.: 17/112,259

(22) Filed: Dec. 4, 2020

Related U.S. Application Data
(60) Provisional application No. 62/944,562, filed on Dec. 6, 2019.

(51) Int. Cl. F16L 55/175; B29C 63/30; B29C 63/00

(52) U.S. Cl. CPC F16L 55/175; B29C 63/0021; B29C 63/30

(57) ABSTRACT

A method of repairing a pipe and a repaired pipe are described. A curable material is sprayed onto a wall of the pipe and cured. A fabric including a curable material is also positioned along the pipe wall and resin carried by the fabric cured. The sprayed on curable material and fabric are superposed on the pipe wall. The repaired pipe includes the superposed sprayed-in-place curable material and the fabric to provide reinforcement against internal pressure and external loads applied to the pipe.

### CROSS-REFERENCE TO RELATED APPLICATION

This application claims priority to U.S. Provisional Patent Application No. 62/944,562, which was filed on Dec. 6, 2019, under the title, “Method of Reinforcing Pipe and Reinforced Pipe.”

### FIELD

The present disclosure relates generally to the repair of pipes and more particularly to methods of reinforcing existing host pipes against internal and external loads.

### BACKGROUND

Over time or because of a particular event or condition (e.g., seismic activity, exposure to excessive or uneven loads or moments, exposure to micro-organisms, poor compaction, crown corrosion, corrosive soil, etc.), the structural integrity or capacity of force mains, other pipes and other structures may diminish. For example, such items may crack, corrode, deteriorate and the like. Different methods of repairing or otherwise strengthening damaged pipes and other items are well-known.

### SUMMARY

In one aspect of the present invention, a method of reinforcing a pipe having a pipe wall generally comprises spraying a curable flowable material along the pipe wall and curing the curable flowable material to form in-place a layer of sprayed-in-place reinforcement along the pipe wall. A fiber-laden fabric is positioned along the pipe wall and curable polymer impregnated in the fiber-laden fabric is cured to form in-place a layer of fabric reinforcement along the pipe wall. Following completion of said steps of spraying and positioning, the layer of sprayed-in-place reinforcement and layer of fabric reinforcement are superposed with each other.

In another aspect of the present invention, a reinforced pipe system generally comprises an existing host pipe having a pipe wall and a layer of sprayed-in-place reinforcement in the interior of the host pipe extending along the pipe wall. A further layer of fabric reinforcement in the interior of the host pipe extends along the pipe wall. The layer of sprayed-in-place reinforcement is free of fabric. The layer of fiber reinforcement includes fiber-laden fabric. The layer of sprayed-in-place reinforcement and the layer of fabric reinforcement are superposed with each other along the pipe wall.

Other aspects and features will be apparent hereinafter.

### BRIEF DESCRIPTION OF THE DRAWINGS

FIG. 1 is a schematic cross section of a host pipe in need of rehabilitation;

FIG. 2 is a schematic cross section of a rehabilitated pipe;

FIG. 3 is a schematic cross section of another rehabilitated pipe; and

FIG. 4 is a schematic cross section of another rehabilitated pipe.

Corresponding reference characters indicate corresponding parts throughout the several views of the drawings.

### DETAILED DESCRIPTION

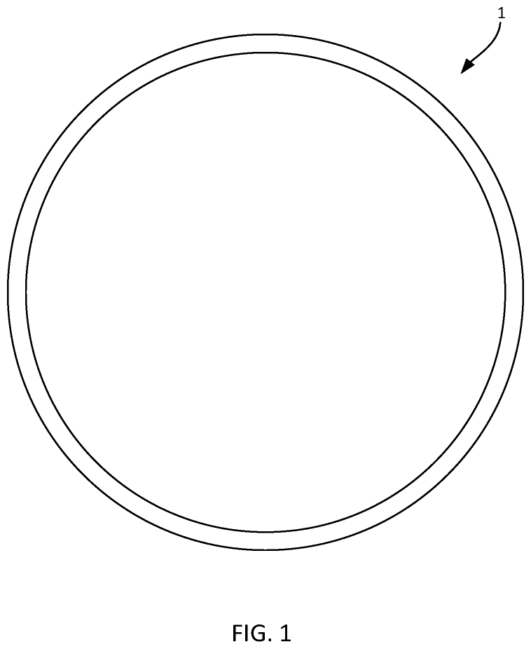

Referring to FIG. 1, a pipe 1 shown schematically has structural damage and is in need of repair. In one or more embodiments, the pipe 1 is a high pressure pipe which carries pressurized fluid that may leak out of a break in the pipe. For instance, in one or more embodiments, the pipe 1 comprises a force main or a water pipeline having a diameter in an inclusive range of from about 30 inches to about 240 inches. Pipes suitable for repair using aspects of the present invention may have other diameters outside of the foregoing range. The pressurized fluid inside the pipe creates an internal load on the pipe, but there are often also external loads. For example, the pipe 1 may be an underground pipe, subject to external seismic loading and other types of external loads. In some cases, the damage to the pipe 1 can take the form of large openings, small openings, hairline fractures, or other breakage. The damage can be no more than a crack or pinhole that extends through the side wall 5 of the pipe. In some cases, the pipe structure can merely be weakened and in need of reinforcement, though the pipe 1 is still impervious to leakage. Certain pipes may have a maximum useful life that, when exceeded, requires replacement or reinforcement of the pipe.

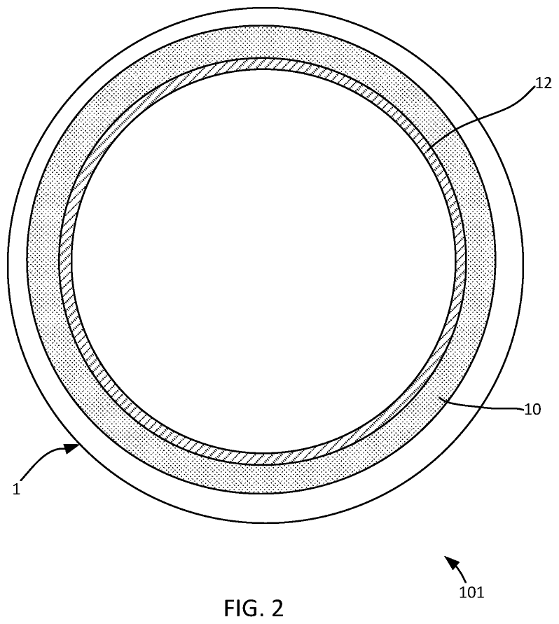

Aspects of this disclosure pertain to a method of repairing the pipe 1 to reinforce the pipe to withstand both internal and external loads. Referring to FIG. 2, a method is disclosed below in which two distinct layers of reinforcement 10, 12 with different strength properties are applied to the pipe 1 to form a reinforced pipe 101. Broadly speaking, at least one layer of reinforcement 10 comprises material having relatively great compressive strength and another layer of reinforcement 12 comprises material having relatively great tensile strength. In an exemplary embodiment, a first layer of reinforcement 10 comprises cured flowable polymer that was sprayed-in-place and is not a fabric. In an exemplary embodiment, the layer 10 comprises sprayed-in-place pipe (SIPP) reinforcement. In certain embodiments, a second layer of reinforcement 12 comprises a layer of fiber-reinforced polymer (FRP) or cured-in-place pipe (CIPP) formed from fiber-laden fabric impregnated with polymer. Throughout this disclosure, FRP and CIPP reinforcement will be broadly termed “fabric reinforcement,” which generally refers to any reinforcement that is formed from fiber laden fabric and distinguishes sprayed-in-place reinforcement which lacks fiber-laden fabric. Thus a “layer of fabric reinforcement” can broadly refer to a layer of FRP supported on a host pipe or a layer of CIPP supported on a host pipe. Fabric reinforcement in the scope of this disclosure can include high tensile strength fibers such as glass fibers, carbon fibers, aramid fibers, etc.

In one method of forming the reinforced pipe 101, an interior surface of the host pipe 1 is first prepared for rehabilitation. For example, an installation technician prepares an inner surface of a wall of the pipe 1 by cleaning, abrading, priming and/or drying the surface. In addition, if the surface has surface voids, they can be filled with an epoxy or other filler. If the wall of the pipe 1 has breaches, they can be at least temporarily blocked to prevent groundwater from infiltrating the pipe during later steps of the method. Generally, no pressurized fluid will be present in the pipe during the method. Many conventional pipe reinforcement methods require coating the inner surface of the host pipe with a tack coat before placing the reinforcing materials onto the host pipe. However, in the illustrated embodiment, the sprayed-in-place layer 10 is sprayed directly onto the prepared surface of the host pipe without first applying a tack coat. The inventors have determined that the desired reinforcement characteristics can be achieved this way without use of a tack coat. However, it will be understood that a tack coat may be applied on the host pipe's inner surface in one or more embodiments, without departing from the scope of the disclosure.

As shown in FIG. 2, after preparing the inner surface of the host pipe 1, the layer of sprayed-in-place reinforcement 10 is then formed along the pipe wall 5. In the illustrated embodiment, the layer of sprayed-in-place reinforcement 10 is applied to contact the inner surface of the pipe 1 about an entire inner perimeter of the pipe along a desired length of the pipe. In general, the process of installing the layer of sprayed-in-place reinforcement 10 comprises spraying a curable flowable material onto the inner surface of the host pipe 1 until a layer of substantially even thickness is applied about the entire inner perimeter and along the entire desired length. Any robotic or mechanical sprayed-in-place system for applying sprayed-in-place reinforcement can be used to apply the sprayed-in-place layer of reinforcement 10. The sprayed-in-place reinforcement 10 can also be installed by hand using, for example, an industrial texture sprayer or other form of spray gun. Hand spraying the reinforcement 10 may be the preferred method for very large diameter pipes. It is contemplated that the layer of sprayed-in-place reinforcement 10 could be formed in one pass or multiple passes to build up the thickness of the layer.

Any suitable curable flowable material can be used to form the layer of sprayed-in-place reinforcement 10. Generally, curable flowable materials should be compatible with the layer of fabric reinforcement 12. For instance, the curable flowable material forming the sprayed-in-place reinforcement 10 should be capable of directly adhering to the curable polymer in the layer of fabric reinforcement 12 (discussed below). For example, the layer of sprayed-in-place reinforcement 10 is configured such that a layer of fabric reinforcement 12 material can adhere to its interior surface after the layer of sprayed-in-place reinforcement is fully cured. In an embodiment, the layer of sprayed-in-place reinforcement 10 is formed from a geopolymer mortar, for example a micro-fiber reinforced ultra-dense geopolymer mortar. An exemplary geopolymer mortar within the scope of this disclosure is GeoSpray®, available from the GeoTree™ Solutions brand of ClockSpring/NRI, located in Houston, Tex. It is also contemplated that other types of curable flowable materials can be used to form the layer of sprayed-in-place reinforcement 10. For instance, in one or more embodiments, the layer of sprayed-in-place reinforcement is formed from a cement mortar or a polyurea such as 3M™ Skotchkote™.

After spraying the curable flowable material onto the interior surface of host pipe 1, the material is cured to form in-place the layer of sprayed-in-place reinforcement 10. The material can be allowed to cure in ambient conditions or more rapidly cured using heat, UV, or other curing stimulant. Once cured, the layer of sprayed-in-place reinforcement 10 imparts compressive strength to the reinforced pipe 101, which reinforces the host pipe 1 against external loads.

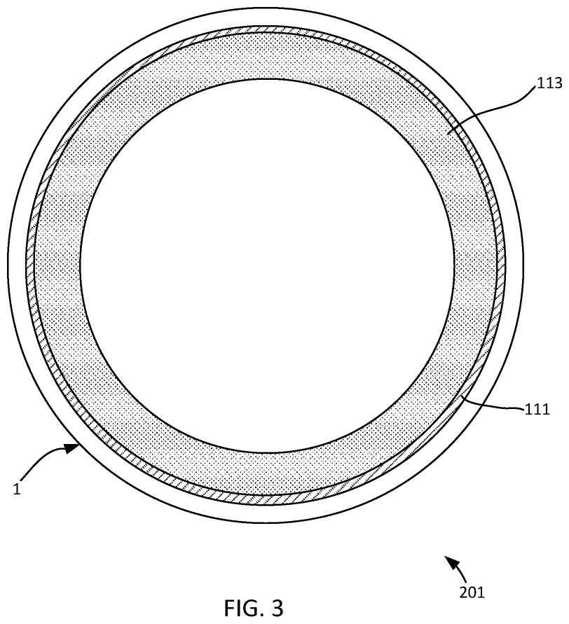

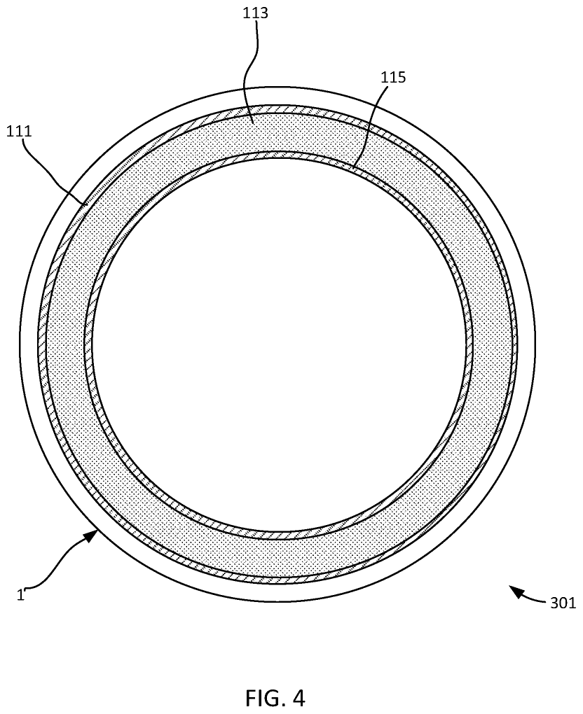

Referring still to FIG. 2, after installing the layer of sprayed-in-place reinforcement 10 as a first layer directly on the inner surface of the host pipe 1, the layer of fabric reinforcement 12 is installed as a second layer, directly on the inner surface of the first layer. In the illustrated embodiment, the layer of fabric reinforcement 12 contacts the inner surface of the layer of sprayed-in-place reinforcement 10 about an entire inner perimeter of the layer of sprayed-in-place reinforcement and along substantially the entire length of the layer of sprayed-in-place reinforcement. As explained above, in an exemplary embodiment, the layer of fabric reinforcement 12 comprises FRP or CIPP material. Typically, the layer of fabric reinforcement 12 will be installed shortly after the layer of sprayed-in-place reinforcement 10 cures (e.g., the layer of fabric reinforcement 12 will often be installed less than 48 hours after installation of the layer of sprayed-in-place reinforcement; the layer of fabric reinforcement may also be installed before service is restored to the host pipe 1 after the layer of sprayed-in-place reinforcement is installed). Accordingly, the layer of sprayed-in-place reinforcement 10 will be in new condition such that no surface preparation is required. However, it is also contemplated that, in certain embodiments of a reinforced host pipe including both a sprayed-in-place layer and a fabric layer, the fabric layer could be installed on a non-new surface (e.g., directly on the host pipe 1 before the sprayed-in-place layer (see, FIGS. 3 and 4), or the fabric layer could be installed atop a sprayed-in-place layer that has become worn or damaged). In these embodiments, the technician can appropriately prepare the interior surface to which the layer of fabric reinforcement 12 will be applied.

In an exemplary embodiment, the layer of fabric reinforcement 12 comprises fiber-laden fabric impregnated with curable polymer. In one or more embodiments, the fiber-laden fabric includes high tensile strength fibers held together by a fabric architecture such as weave, a knit, felting, a braid, stitching, needle punching, or the like. In certain embodiments, the fiber-laden fabric has a strong direction and fibers of the fabric extending in the strong direction have greater aggregate tensile strength than fibers of the fabric extending in directions transverse to the strong direction. It is also contemplated that certain fiber-laden fabrics within the scope of this disclosure can be bi-axial or multi-axial fabrics having similar tensile strengths along multiple axes (e.g., along a 0° axis and a 90° axis; ±45° axes; a 0° axis, a 90° axis, and a 45° axis; or a 0° axis, a 90° axis, and a ±45° axes).

In one or more embodiments, the process of forming the layer of fabric reinforcement 12 comprises impregnating fiber-laden fabric with a curable polymer (e.g., a resin, e.g., Tyfo® S epoxy available from Fyfe Co. LLC of San Diego, Calif.) or a moisture-cured urea-urethane polymer. In the illustrated embodiment, an installer then positions the impregnated fabric in the interior of the host pipe 1 along the pipe wall such that impregnated fabric covers substantially an entire inner perimeter of the sprayed-in-place layer 10 along a length of the host pipe being repaired. Because the fabric reinforcement is being applied directly on the newly finished surface of the sprayed-in-place reinforcement 10, no preparation or tack coat is required. In an exemplary embodiment, the fiber-laden fabric is positioned such that at least some of the fibers in the fiber-laden fabric extend generally in the hoop direction of the pipe 1. Suitably, the fiber-laden fabric is positioned such that the strong direction extends generally in the hoop direction of the pipe 1. For example, in certain embodiments, a majority of the fibers in the fiber-laden fabric extend generally in the hoop direction of the host pipe 1 once the fiber-laden fabric is positioned in the host pipe. It is not necessary that a majority of fibers extend in the strength direction. It may be that fibers of higher strength extend in the strength direction. In a preferred embodiment, the fiber-laden fabric is impregnated prior to being placed on the wall of the pipe 1. However, the fiber-laden fabric could also be placed at the desired position before being impregnated with a curable polymer without departing from the scope of the invention. In such an embodiment, the fiber-laden fabric would be impregnated with a curable polymer after it is positioned on the layer of sprayed-in-place reinforcement.

After applying the impregnated fiber-laden fabric to the interior surface of the layer of sprayed-in-place reinforcement 10, the curable polymer impregnated in the fabric is cured to form in-place the layer of fabric reinforcement 12. The curable polymer used in the layer of fabric reinforcement 12 can be allowed to cure in ambient conditions or more rapidly cured using heat, UV, or other curing stimulant. It will be understood that the order and timing of curing the sprayed-in-place reinforcement 10 and the fabric reinforcement 12 can be adjusted as desired. Once cured, the layer of fabric reinforcement 12 imparts tensile strength in the hoop direction to the reinforced pipe 101, which reinforces the host pipe 1 against internal loads.

One technique for installing a layer of fabric reinforcement is described in U.S. Pat. No. 5,931,198, which is assigned to the assignee of the present invention and which is attached hereby incorporated by reference in its entirety. In U.S. Pat. No. 5,931,198, the impregnated fiber-laden fabric is pressed against the host pipe by hand. The system and method described in U.S. Pat. No. 5,931,198 produces a structurally reinforced pipe (FIG. 2) that is structurally reinforced to a certain degree. This is the conventional technique used to form an FRP reinforcement layer. It is also contemplated that the fiber-laden fabric which forms a layer of fabric reinforcement in the scope of the present disclosure can be applied using other CIPP installation techniques, such as by use of an inflatable bladder, by eversion, etc. (See, U.S. Pat. No. 4,064,211, U.S. Patent Application Publication No. 2014/0034175 and International Patent Publication No. WO2014/110544, which are each assigned to the assignee (or predecessor in interest) of the present invention and are all hereby incorporated by reference in their entireties).

The inventors have recognized that the material used in the layer of sprayed-in-place reinforcement 10 is substantially less expensive than the material used in the layer of fabric reinforcement 12 per unit of cross-sectional area of the pipe 1. Thus in one or more embodiments, the wall thickness of the layer of sprayed-in-place reinforcement 10 is greater than the wall thickness of the layer of fabric reinforcement 12. For example, in an embodiment, the wall thickness of the layer of sprayed-in-place reinforcement 10 is at least four-times greater than the thickness of the layer of fabric reinforcement 12 (e.g., at least eight-times greater, at least twelve-times greater, at least twenty-times greater). In one or more embodiments, the thickness of the layer of fabric reinforcement layer 12 is less than about 1 inch (e.g., less than 0.5 inches, less than 0.25 inches) and the thickness of the layer of sprayed-in-place reinforcement 10 is less than about 6 inches (e.g., less than 4 inches). In certain embodiments, the thickness of the layer of sprayed-in-place reinforcement 10 is greater than about 0.5 inches (e.g., greater than 1 inch, greater than 1.5 inches, greater than 2.0 inches). Increasing the thickness of the sprayed-in-place layer 10 provides enhanced compressive strength in the reinforced pipe 101.

As can be seen, the first and second layers of reinforcement 10, 12 form a composite reinforced pipe 101 that reinforces the preexisting host pipe 1. The first and second layers of reinforcement 10, 12 each provide different strength properties. Together, the two layers of reinforcement act to reinforce the host pipe 1 against both internal and external loads.

In one or more embodiments, the layer of sprayed-in-place reinforcement 10 is configured to reinforce the host pipe 1 against external loads. In one or more embodiments, the tensile strength in the hoop direction of the sprayed-in-place material is less than that of the fabric reinforcement. Thus, devoid of the fabric layer 12 (whose strength properties are discussed below), the layer of sprayed-in-place reinforcement imparts only limited resistance to mechanical failure in response to internal loads. In an exemplary embodiment, the sprayed-in-place material has a compressive strength of at least about 2000 psi. Forming the sprayed-in-place material to be greater in thickness than the fabric layer 12 enables the layer of sprayed-in-place reinforcement to substantially enhance the resistance to mechanical failure due to externally applied loads, in comparison with the layer of fabric reinforcement alone, which can be prone to buckling. The high compressive strength layer 10 reinforces the host pipe 1 against external loads applied to the pipe. Suitably, the layer of sprayed-in-place reinforcement 10 can also have a flexural strength of at least about 400 psi. Strength properties of certain exemplary (non-limiting) materials usable to form a composite reinforced pipe in accordance with the present disclosure are provided in the following Table 1:

TABLE 1
Strength Properties of Exemplary Materials
for Use in Forming Reinforced Pipe

| | Tension | | Flexural | | Flexural | |
|---|---|---|---|---|---|---|
| | Strength | | Strength | | Modulus | |
| Material | (ksi) | | (ksi) | | (ksi) | |
| Carbon Fiber | 100-140 | ksi | 80-120 | ksi | 7,000-12,000 | ksi |
| Reinforced Polymer | | | | | | |
| (CFRP) | | | | | | |
| Glass Fiber Reinforced | 60-100 | ksi | 60-100 | ksi | 2,500-4,500 | ksi |
| Polymer (GFRP) | | | | | | |
| Cured-in-Place Pipe | 3-20 | ksi | 3-6 | ksi | 200-1,000 | ksi |
| (CIPP) | | | | | | |

| | | | | |
|---|---|---|---|---|
| Geopolymer and | — | — | 450-500 | ksi |
| CFRP Application | | | | |
| Geopolymer and | — | — | 500-600 | ksi |
| GFRP Application | | | | |
| Geopolymer and | — | — | 300-600 | ksi |
| CIPP Application | | | | |

The layer of fabric reinforcement 12 has relatively great tensile strength in the hoop direction of the pipe 1. In one or more embodiments, the material forming the layer of fabric reinforcement 12 has a tensile strength in the hoop direction of at least about 10 ksi. Even though a relatively thin layer of material is used for the layer of fabric reinforcement 12, it provides good resistance to mechanical failure (e.g., rupture) in response internal loads that are imparted on the pipe 1. However, because the layer of fabric reinforcement 12 is relatively thin, it does not provide substantial resistance to buckling or other types of mechanical failure due to external loads imparted on the pipe 1. As explained above, the layer of fabric reinforcement 12 comprises a fiber-laden fabric with high tensile strength fibers, and a substantial portion (e.g., a majority) of the high tensile strength fibers extend in the hoop direction of the pipe. The layer of fabric reinforcement 12 thus reinforces the host pipe 1 against internal loads applied by the pressurized fluid flowing through the pipe, thereby complementing the high compressive strength characteristics of the sprayed-in-place reinforcement layer 10. Thus, in combination, the two layers of reinforcement 10, 12 impart both tensile strength and compressive strength to the reinforced pipe 101 to reinforce the host pipe against both internal and external loads.

Referring to FIG. 3, in another embodiment, a reinforced host pipe 201 comprises a first layer of fabric reinforcement 111 formed fiber-laden fabric material and second layer of sprayed-in-place reinforcement 113 formed from curable flowable material (free of fiber-laden fabric) sprayed onto the inner surface of the layer of fabric reinforcement. Thus, the illustrated reinforced host pipe 201 is substantially the same as the reinforced host pipe 101 except that the positions of the sprayed-in-place reinforcement and fabric reinforcement are switched in the two pipes. The strength characteristics and thicknesses of the layer of fabric reinforcement 111 can be in the same range as those of the layer of fabric reinforcement 12 discussed above. Likewise, the strength characteristics and thickness of the layer of sprayed-in-place reinforcement 113 can be the same range of those of the layer of sprayed-in-place reinforcement 10 discussed above. The method of forming the reinforced host pipe 201 is substantially the same as the method of forming the reinforced host pipe 101 except that, after preparing the inner surface of the host pipe 1, the layer of fabric reinforcement 111 is installed first. Whereas the direct application of sprayed-in-place material onto the host pipe 1 rendered a tack coat unnecessary to form the reinforced host pipe 101 of FIG. 2, in an exemplary embodiment, when the layer of fabric reinforcement is the first layer of reinforcement applied to the host pipe 1, as in FIG. 3, a tack coat may be applied to the inner surface of the host pipe before placing the layer of fabric reinforcement 111 onto the inner surface of the host pipe. However, in some instances the layer of fabric reinforcement 111 may be applied to the inner surface of the host pipe without a tack coat. Typically, the layer of sprayed-in-place reinforcement 113 will be installed shortly after layer of fabric reinforcement 111 cures (e.g., the layer of sprayed-in-place reinforcement will often be installed less than 48 hours after installation of the layer of fabric reinforcement; the layer of sprayed-in-place reinforcement may also be installed before service is restored to the host pipe 1 after the layer of fabric reinforcement is installed).

Referring to FIG. 4, in another embodiment, a reinforced host pipe 301 comprises an outer layer of fabric reinforcement 111 (broadly, a first layer of fabric reinforcement) and a layer of sprayed-in-place reinforcement 113 inside the outer layer of fabric reinforcement, just as in the reinforced host pipe 201 of FIG. 3, but also further comprises an inner layer of fabric reinforcement 115 (broadly, a second layer of fabric reinforcement). In the illustrated embodiment, the inner layer of fabric reinforcement 115 comprises another layer of fabric reinforcement having relatively great tensile strength in the hoop direction. The inner layer of fabric reinforcement 115 can be installed using any of the techniques described above with respect to the layer of fabric reinforcement 12. It can be seen in FIG. 4 that the inner layer of fabric reinforcement 115 is installed inside the sprayed-in-place layer 113 so that the sprayed in place layer is sandwiched between the outer and inner fabric layers 111, 115. Typically, the inner layer of fabric reinforcement 115 will be installed shortly after the layer of sprayed-in-place reinforcement 113 cures (e.g., the third layer of reinforcement will often be installed less than 48 hours after installation of the layer of sprayed-in-place reinforcement; the third layer of reinforcement may also be installed before service is restored to the host pipe 1 after the layer of sprayed-in-place reinforcement is installed). Thus, in certain embodiments, it may not be necessary to prepare the interior surface of the layer of sprayed-in-place reinforcement 113 before applying a tack coat. It is also envisioned that the tack coat may be omitted.

In one or more embodiments, the inner layer of fabric reinforcement 115 comprises fiber-laden fabric comprising high tensile strength fibers and a substantial portion (e.g., a majority) of the high tensile strength fibers of the inner layer of fabric reinforcement extend generally in the hoop direction of the pipe 1. Thus, the inner layer of fabric reinforcement 115 can impart substantial tensile strength in the hoop direction of the pipe 1. In one or more embodiments, the inner layer of fabric reinforcement 115 has a tensile strength in the hoop direction of at least about 10 ksi. By contrast in certain embodiments, the compressive strength of the inner layer of fabric reinforcement 115 is relatively low. In certain embodiments, the thickness of the layer of sprayed-in-place reinforcement 113 is at least four-times greater than the thickness of the inner layer of fabric reinforcement 115 (e.g., at least eight-times greater, at least twelve-times greater, at least 20-times greater). In one or more embodiments, the inner layer of fabric reinforcement 115 is less than about 1 inches (e.g., less than 0.5 inches, less than 0.25 inches).

After the inner layer of fabric reinforcement 115 is impregnated, positioned, and cured, the three layers of reinforcement 111, 113, 115 form a composite reinforced pipe 301 that reinforces the preexisting host pipe 1 against both internal and external loads. The outer and inner layers of fabric reinforcement 111, 115 impart tensile strength in the hoop direction of the reinforced pipe 301 and the layer of sprayed-in-place reinforcement 113 imparts compressive strength.

The systems, apparatuses, devices and/or other articles disclosed herein may be formed through any suitable means. The various methods and techniques described above provide a number of ways to carry out the inventions. Of course, it is to be understood that not necessarily all objectives or advantages described may be achieved in accordance with any particular embodiment described herein. Thus, for example, those skilled in the art will recognize that the methods may be performed in a manner that achieves or optimizes one advantage or group of advantages as taught herein without necessarily achieving other objectives or advantages as may be taught or suggested herein.

Furthermore, the skilled artisan will recognize the interchangeability of various features from different embodiments disclosed herein. Similarly, the various features and steps discussed above, as well as other known equivalents for each such feature or step, can be mixed and matched by one of ordinary skill in this art to perform methods in accordance with principles described herein. Additionally, the methods which are described and illustrated herein are not limited to the exact sequence of acts described, nor are they necessarily limited to the practice of all of the acts set forth. Other sequences of events or acts, or less than all of the events, or simultaneous occurrence of the events, may be utilized in practicing the embodiments of the invention.

Although the inventions have been disclosed in the context of certain embodiments and examples, it will be understood by those skilled in the art that the inventions extend beyond the specifically disclosed embodiments to other alternative embodiments and/or uses and obvious modifications and equivalents thereof. Accordingly, it is not intended that the inventions be limited, except as by the appended claims.

What is claimed is:

1. A method of reinforcing a pipe having a pipe wall, the method comprising:
spraying a curable flowable material along the pipe wall and curing the curable flowable material to form in-place a layer of sprayed-in-place reinforcement along the pipe wall; and
positioning fiber-laden fabric along the pipe wall and curing curable polymer impregnated in the fiber-laden fabric to form in-place a layer of fabric reinforcement along the pipe wall;
wherein following completion of said steps of spraying and positioning, the layer of sprayed-in-place reinforcement and layer of fabric reinforcement are superposed with each other.

2. The method as set forth in claim 1, wherein the layer of sprayed-in-place reinforcement and the layer of fabric reinforcement have different strength properties.

3. The method as set forth in claim 2, wherein the layer of sprayed-in-place reinforcement has greater compressive strength than the layer of fabric reinforcement.

4. The method as set forth in claim 2, wherein the layer of fabric reinforcement has greater tensile strength than the layer of sprayed-in-place reinforcement.

5. The method as set forth in claim 1, wherein the spraying the curable flowable material is carried out prior to the positioning of fiber-laden fabric.

6. The method as set forth in claim 1, wherein the layer of fabric reinforcement is applied directly to an interior surface of the layer of sprayed-in-place reinforcement.

7. The method as set forth in claim 1, wherein the curable flowable material comprises a mortar.

8. The method as set forth in claim 1, wherein the curable flowable material comprises a polymer.

9. The method as set forth in claim 1, wherein the curable flowable material comprises an inorganic polymeric resin.

10. The method as set forth in claim 1, wherein the curable flowable material comprises a geopolymer mortar.

11. The method as set forth in claim 10, wherein the geopolymer mortar is reinforced with microfibers.

12. The method as set forth in claim 1, wherein the layer of fabric reinforcement is a first layer of fabric reinforcement, the method further comprising positioning additional fiber-laden fabric along the pipe wall and curing curable polymer impregnated in the additional fiber-laden fabric to form in-place a second layer of fabric reinforcement along the pipe wall.

13. The method as set forth in claim 12, wherein the layer of sprayed-in-place reinforcement is sandwiched between the first layer of fabric reinforcement and the second layer of fabric reinforcement.

14. The method as set forth in claim 1, wherein said spraying the curable polymer comprises spraying the curable polymer directly onto an inner surface of the host pipe without applying a tack coat.

15. A reinforced pipe system comprising:
an existing host pipe having a pipe wall;
a layer of sprayed-in-place reinforcement in the interior of the host pipe extending along the pipe wall; and
a layer of fabric reinforcement in the interior of the host pipe extending along the pipe wall;
wherein the layer of sprayed-in-place reinforcement is free of fabric;
wherein the layer of fiber reinforcement includes fiber-laden fabric;
wherein the layer of sprayed-in-place reinforcement and the layer of fabric reinforcement are superposed with each other along the pipe wall.

16. The reinforced pipe system as set forth in claim 14, wherein the layer of sprayed-in-place reinforcement has greater compressive strength than the layer of fabric reinforcement.

17. The reinforced pipe system as set forth in claim 14, wherein the layer of fabric reinforcement has greater tensile strength than the layer of sprayed-in-place reinforcement.

18. The reinforced pipe system as set forth in claim 14, wherein the layer of sprayed-in-place reinforcement comprises geopolymer mortar.

19. The reinforced pipe system as set forth in claim 14, wherein layer of sprayed-in-place reinforcement conforms to an interior surface of the host pipe and the layer of fabric reinforcement conforms to an interior surface of the layer of sprayed-in-place reinforcement.

20. The reinforced pipe system as set forth in claim 14, wherein the layer of fabric reinforcement comprises a first layer of fabric reinforcement and a second layer of fabric reinforcement, the layer of sprayed-in-place reinforcement being sandwiched between the first layer of fabric reinforcement and the second layer of fabric reinforcement.
